(19) United States
(12) Patent Application Publication
(10) Pub. No.: US 2015/0338692 A1
(43) Pub. Date: Nov. 26, 2015

(54) DISPLAY DEVICE

(71) Applicant: Samsung Display Co., Ltd., Yongin City (KR)

(72) Inventor: KIM Yu-Jin, Asan-si (KR)

(21) Appl. No.: 14/504,887

(22) Filed: Oct. 2, 2014

(30) Foreign Application Priority Data
May 21, 2014 (KR) 10-2014-0060863

(51) Int. Cl. G02F 1/133; G02F 1/1333; G02F 1/1335; G02F 1/1368

(52) U.S. Cl. CPC G02F 1/13306; G02F 1/1368; G02F 1/133345; G02F 1/133512; G02F 1/133514

(57) ABSTRACT

According to an embodiment of the present system and method, a display device includes first and second panels combined with a light transmitting layer positioned therebetween. The first panel includes a first insulation substrate including a display area and a peripheral area around the display area, a plurality of signal lines positioned in the display area of the first insulation substrate, and a driving circuit integrated in the peripheral area of the first insulation substrate and connected to the plurality of signal lines. The second panel includes a second insulation substrate facing the first insulation substrate, an insulating layer positioned on the second insulation substrate, a conductive low resistance layer positioned on the insulating layer and having lower resistance than the insulating layer, and an overcoat positioned on the low resistance layer and including an insulating material, wherein the low resistance layer includes a first portion facing the driving circuit.

### CROSS-REFERENCE TO RELATED APPLICATION

This application claims priority to and the benefit of Korean Patent Application No. 10-2014-0060863 filed in the Korean Intellectual Property Office on May 21, 2014, the entire contents of which are incorporated herein by reference.

### BACKGROUND

(a) Technical Field

The present system and method relate to a display device, and in particular, relate to a display device that includes a driving circuit integrated in a display panel.

(b) Description of the Related Art

A display device generally includes a display panel, which contains pixels, switching elements, and display signal lines, a gate driver that transmits gate signals to gate lines among the display signal lines to turn the switching elements of the pixels on and off, a data driver that applies data voltages to data lines, a signal controller that controls the display panel, the gate driver, and the data driver, and the like.

A liquid crystal display among the display devices, which may be one of the most common types of flat panel displays currently in use, includes two sheets of panels with field generating electrodes, such as a pixel electrode and a common electrode, and a liquid crystal layer interposed therebetween. The liquid crystal display generates an electric field in the liquid crystal layer by applying a voltage to the field generating electrodes, which affects the direction of liquid crystal molecules of the liquid crystal layer, and thereby controls the polarization of incident light so as to display images. That is, the transmittance of the liquid crystal display may be increased by using an electric field to control the orientation, shape, and/or position of the liquid crystal molecules.

At least one pixel electrode included in each pixel of the liquid crystal display is connected to the switching element, which is connected to the display signal lines such as the gate line and the data line. The switching element may be a three-terminal element such as a thin film transistor and transfer a data voltage to the pixel electrode.

In the liquid crystal display, the pixel electrode and the common electrode that generate the electric field in the liquid crystal layer may be provided on one display panel with the switching element. At least one of the pixel electrode and the common electrode of the liquid crystal display may include a plurality of branch electrodes. When the electric field is generated in the liquid crystal layer, the alignment directions of the liquid crystal molecules of the liquid crystal layer are determined by a fringe field generated by the branch electrodes.

A driving circuit such as the gate driver and the data driver may be mounted on the display device in an IC chip form, mounted on a flexible printed circuit film to be attached to the display device in a tape carrier package (TCP) form, or mounted on a printed circuit board. In some cases, the gate driver may be integrated in the display panel (i.e., not formed as a separate chip) by the same process that forms the display signal lines and the switching element.

The gate driver includes a shift resistor configured by a plurality of stages dependently connected to each other, and a plurality of signal lines that transfer the driving signal to the shift resistor. The plurality of stages include a plurality of thin film transistors and capacitors. Each stage is connected to a corresponding gate line, and the plurality of stages sequentially output the gate signals to each gate line in a predetermined order.

In the display device in which the driving circuit such as the gate driver is integrated in the display panel, the charges may build up in a layer in which the resistance of the upper panel is relatively low as a voltage difference that is generated when the driving circuit is turned on or off. The charges accumulated in this way may be transmitted to a side of a display area of the display panel and cause an undesired electric field to be generated, affecting an optical conversion element such as the liquid crystal layer. This undesired electric field may be substantial in an edge portion of the display area near the driving circuit and cause light leakage. The light leakage of the edge portion of the display area may be seen when displaying a black or a low gray image. Particularly, when the voltage being transmitted in the driving circuit has a large potential difference with respect to a common voltage being transmitted in the display area, the light leakage may be further exacerbated.

### SUMMARY

The present system and method prevent a display stain due light leakage generated in a display area by rapidly dispersing charges charged to an upper panel by a voltage transmitted in a driving circuit of a display device in which a driving circuit is integrated in a display panel to a wide area.

A display device according to an exemplary embodiment of the present system and method includes a first panel, a second panel, and a light transmitting layer. The first panel includes a first insulation substrate including a display area and a peripheral area around the display area, a plurality of signal lines positioned in the display area of the first insulation substrate, and a driving circuit integrated in the peripheral area of the first insulation substrate and connected to the plurality of signal lines. The second panel includes a second insulation substrate facing the first insulation substrate, an insulating layer positioned on the second insulation substrate, a conductive low resistance layer positioned on the insulating layer and having lower resistance than the insulating layer, and an overcoat positioned on the low resistance layer and including an insulating material, wherein the low resistance layer includes a first portion facing the driving circuit, and the first and second panels are combined with the light transmitting layer positioned therebetween.

A first electrode and a second electrode positioned on the first insulation substrate may be further included, and the first electrode and the second electrode may form an electric field according to an image signal between the first insulation substrate and the second insulation substrate.

The first portion may cover substantially most of the peripheral area.

A color filter positioned between the low resistance layer and the overcoat may be further included.

The low resistance layer may include an opening corresponding to the display area.

A short portion positioned between the first insulation substrate and the second insulation substrate may be further included, and the short portion may be connected to the low resistance layer.

A voltage wire positioned on the first insulation substrate and transmitting a predetermined voltage may be further included, and the short portion may be connected to the voltage wire.

The overcoat may include a contact hole exposing the low resistance layer.

The driving circuit may generate a gate signal including a gate-on voltage and a gate-off voltage.

The low resistance layer may further include a second portion positioned in the display area, and the second portion may be connected to the first portion.

The insulating layer may include a first light blocking portion positioned in the peripheral area and a second light blocking portion positioned in the display area, the second light blocking portion may include a plurality of first openings, and the second portion may include a second opening facing the first openings.

According to an exemplary embodiment of the present system and method, charges that would otherwise build up in the upper panel due to the voltage being transmitted by a driving circuit that is integrated in the display panel may be rapidly dispersed in a large area, thereby reducing or even preventing light leakage in the partial region of the display and increasing the display quality.

### BRIEF DESCRIPTION OF THE DRAWINGS

FIG. 1 is a block diagram of a display device according to an exemplary embodiment of the present system and method,

FIG. 2 is a schematic circuit diagram of one pixel of a display device according to an exemplary embodiment of the present system and method,

FIG. 3 is a layout view of a display panel included in a display device according to an exemplary embodiment of the present system and method,

FIG. 4 is a cross-sectional view of the display panel of FIG. 3 taken along a line IV-IV,

FIG. 5 is a circuit diagram of one stage of a driver according to an exemplary embodiment of the present system and method,

FIG. 6 and FIG. 7 are cross-sectional views of a display panel according to an exemplary embodiment of the present system and method, respectively,

FIG. 8 to FIG. 11 are cross-sectional views that sequentially show a structure at intermediate steps of a manufacturing process for a display panel according to an exemplary embodiment of the present system and method,

FIG. 12 to FIG. 14 are cross-sectional views that sequentially show a structure at intermediate steps of a manufacturing process for a display panel according to an exemplary embodiment of the present system and method,

FIG. 15 is a layout view of one pixel of a display panel according to an exemplary embodiment of the present system and method,

FIG. 16 is a cross-sectional view of the display panel of FIG. 15 taken along a line XVI-XVI,

FIG. 17 is a simulation result that shows a movement of liquid crystal molecules when a pixel electrode and a common electrode of a display device generate an electric field to a liquid crystal layer, according to an exemplary embodiment of the present system and method,

FIG. 18 is an enlarged view of a portion of FIG. 17,

FIG. 19 is a simulation result that shows a movement of liquid crystal molecules when a pixel electrode and a common electrode of a display device generate an electric field to a liquid crystal layer, according to an exemplary embodiment of the present system and method,

FIG. 20 is an enlarged view of a portion of FIG. 19,

FIG. 21 is a simulation result that shows a movement of liquid crystal molecules when a pixel electrode and a common electrode of a display device generate an electric field to a liquid crystal layer, according to an exemplary embodiment of the present system and method,

FIG. 22 is an enlarged view of a portion of FIG. 21,

FIG. 23, FIG. 24, and FIG. 25 are layout views of a display panel according to an exemplary embodiment of the present system and method,

FIG. 26 is a cross-sectional view of the display panel of FIG. 25 taken along a line XXVI-XXVI, and

FIG. 27 is a layout view of a display panel according to an exemplary embodiment of the present system and method.

### DETAILED DESCRIPTION OF THE EMBODIMENTS

The present system and method will be described more fully hereinafter with reference to the accompanying drawings, in which exemplary embodiments of the system and method are shown. As those skilled in the art would realize, the described embodiments may be modified in various different ways, all without departing from the spirit or scope of the present system and method.

In the drawings, the thickness of layers, films, panels, regions, etc., may be exaggerated for clarity and not drawn to scale. Like reference numerals designate like elements throughout the specification. It is understood that when an element such as a layer, film, region, or substrate is referred to as being “on” another element, it may be directly on the other element or intervening elements may also be present. In contrast, when an element is referred to as being “directly on” another element, there are no intervening elements present.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

A display device including a display panel according to an exemplary embodiment of the present system and method is described below with reference to accompanying drawings.

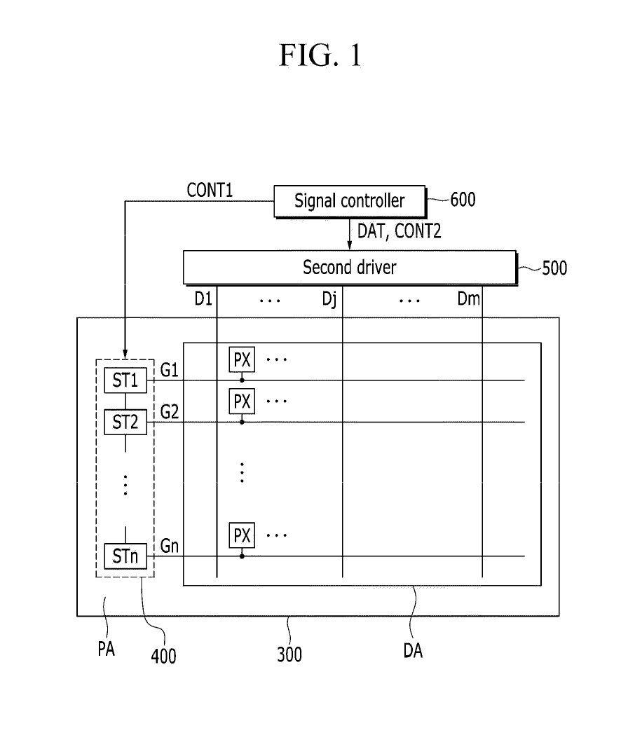

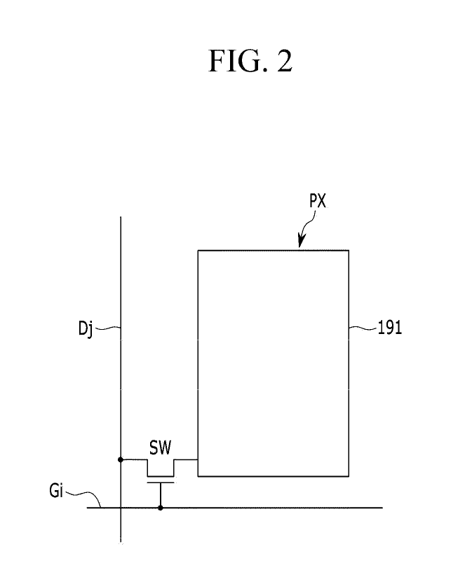

A display device according to an exemplary embodiment of the present system and method is described with reference to FIG. 1 to FIG. 5.

FIG. 1 is a block diagram of a display device according to an exemplary embodiment of the present system and method. FIG. 2 is a schematic circuit diagram of one pixel of a display device according to an exemplary embodiment of the present system and method. FIG. 3 is a layout view of a display panel included in a display device according to an exemplary embodiment of the present system and method.

Referring to FIG. 1, a display device according to an exemplary embodiment of the present system and method includes a display panel 300, a first driver 400, a second driver 500, and a signal controller 600. The display panel 300 may be a display panel included in various display devices such as a liquid crystal display (LCD), an organic light emitting display (OLED), and an electrowetting display (EWD). The display panel 300 includes a display area DA displaying an image, and a peripheral area PA that surrounds the display area DA.

In the display area DA, a plurality of gate lines G1-Gn, a plurality of data lines D1-Dm, and a plurality of pixels PX connected to the plurality of gate lines G1-Gn and the plurality of data lines D1-Dm are positioned. The gate lines G1-Gn may transfer gate signals, extend substantially in a row-wise direction (orientation as shown in FIG. 1), and be substantially parallel to each other. The data lines D1-Dm may transfer data voltages that correspond to the image signals, extend substantially in a column direction, and be substantially parallel to each other. The plurality of pixels PX may be arranged substantially in a matrix form.

Referring to FIG. 2, each pixel PX may include at least one switching element SW that is connected to a gate line Gi, a data line Dj, and at least one pixel electrode 191. The switching element SW may be a three-terminal element such as a thin film transistor integrated in the display panel 300. The thin film transistor includes a gate terminal, an input terminal, and an output terminal. The switching element SW may be turned on or off according to a gate signal of the gate line Gi to transfer a data signal from the data line Dj to the pixel electrode 191. The pixel PX may have a transmittance that corresponds to the data voltage being applied to the pixel electrode 191.

The peripheral area PA is a part of a non-display area in which an image is not displayed in the display device and may be covered by a light blocking member. The peripheral area PA may surround the display area DA or be positioned at an edge of the display panel 300.

Referring to FIG. 1 and FIG. 3, the first driver 400 and a plurality of signal wires SL1 and SL2 that transfer driving signals to the gate driver 400 may be positioned in the peripheral area PA. The signal wire SL1 and the signal wire SL2 may be positioned at different sides with respect to a region in which the first driver 400 is formed. The present system and method, however, is not limited thereto. In another embodiment, the signal wire SL1 and the signal wire SL2 may be positioned in the region in which the first driver 400 is formed or may be positioned at one side with respect to the region in which the first driver 400 is formed.

As FIG. 1 illustrates, the signal controller 600 controls the first driver 400 and the second driver 500 using control signals CONT1 and CONT2, respectively. To generate the control signals, the signal controller 600 processes an input image signal based on the input image signal and an input control signal from an external graphics controller (not shown) and generates a digital image signal DAT, a gate control signal CONT1 and a data control signal CONT2. The signal controller 600 may transmit the data control signal CONT2, the gate control signal CONT1, and the digital image signal DAT to the first driver 400 and the second driver 500.

The second driver 500 may be a data driver that is connected to the data lines D1-Dm of the display panel 300. The second driver 500 receives the data control signal CONT2 and the digital image signal DAT from the signal controller 600, selects a gray voltage that corresponds to each digital image signal DAT (i.e., convert the digital image signal DAT into an analog data signal), and then applies the selected gray voltage to the corresponding data lines D1-Dm.

The second driver 500 may be mounted on the display device in an IC chip form, mounted on a flexible printed circuit film to be attached to the display device in a tape carrier package (TCP) form, or mounted on a printed circuit board. Alternatively, the second driver 500 may be mounted in the peripheral area PA of the display panel 300 as a plurality of IC chips. In another exemplary embodiment of the present system and method, the second driver 500 may be integrated in the peripheral area PA of the display panel 300 along with an electric element such as a thin film transistor of the display area DA in the same process.

The first driver 400 may be a gate driver that is connected to the gate lines G1-Gn. The first driver 400 generates a gate signal such as a gate-on voltage Von and a gate-off voltage Voff according to the gate control signal CONT1 from the signal controller 600, and applies the gate signals to the gate lines G1-Gn.

Referring to FIG. 1 and FIG. 3, the first driver 400 according to an exemplary embodiment of the present system and method may be integrated in the peripheral area PA of the display panel 300. The first driver 400 may include a plurality of stages ST1-STn that are connected to each other and sequentially arranged. The plurality of stages ST1-STn generate gate signals to sequentially transfer the gate signals to the gate lines G1-Gn. Each of the stages ST1-STn includes a gate driving circuit that is connected to each of the gate lines G1-Gn, and may have a gate output terminal (not illustrated) that outputs a gate signal.

The stages ST1-STn of the first driver 400 may be positioned in the peripheral area PA at the left or the right of the display area DA, and arranged in a column-wise direction (orientation as shown in FIG. 1) in a line. In FIG. 1, an example in which the plurality of stages ST1-STn are positioned in the peripheral area PA at the left side of the display area DA is illustrated, but the present system and method are not limited thereto. In another embodiment, the plurality of stages ST1-STn may be positioned in the peripheral area PA at the right side, the upper side, or the lower side of the display area DA (orientation as shown in FIG. 1).

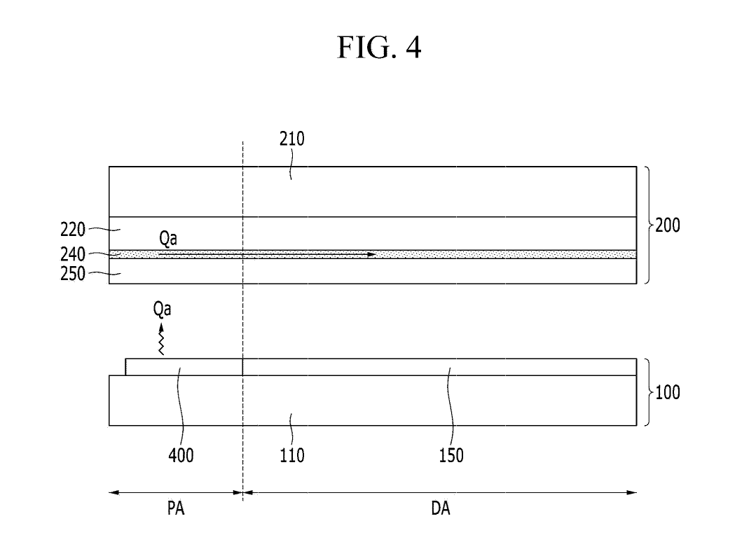

FIG. 4 is a cross-sectional view of the display panel 300 of FIG. 3 taken along a line IV-IV. Referring to FIG. 4, the display panel 300 may include a lower panel 100 and an upper panel 200 that face each other. In the case of a liquid crystal display, a liquid crystal layer (not shown) may be positioned between the lower panel 100 and the upper panel 200.

Referring to the lower panel 100, the first driver 400 is formed on an insulation substrate 110 in the peripheral area PA. Although not shown, the signal wires SL1 and SL2 may be formed around the first driver 400. A display element layer 150 is positioned in the display area DA of the insulation substrate 110. The display element layer 150 may include a plurality of signal lines such as a gate line and a data line, and a plurality of pixels PX connected thereto.

Referring to the upper panel 200, an insulating layer 220 is positioned on an insulation substrate 210. The insulating layer 220 may include an organic insulating material or an inorganic insulating material. The insulating layer 220 has lower conductivity than a conductive material such as a metal. For example, the insulating layer 220 may be a light blocking member that contains a light blocking material such as a black carbon.

A low resistance layer 240 that has lower resistance than the insulating layer 220 is formed on the insulating layer 220. The low resistance layer 240 may include a conductive material such as a metal oxide such as IZO, ITO, and a metal. The low resistance layer 240 includes a portion that faces the first driver 400 and that is positioned at the peripheral area PA. The low resistance layer 240 may be formed to substantially cover all driving circuits, such as the first driver 400 that is integrated in the peripheral area PA, and may be entirely connected as one. The low resistance layer 240 may cover most of the peripheral area PA of the display panel 300 or may partially cover it. The low resistance layer 240, as shown in FIG. 4, may be formed on the entire surface of the insulation substrate 210 and overlap the display area DA, or may be formed only in the peripheral area PA. When the low resistance layer 240 overlaps the driving circuit integrated in the lower panel 100 and is entirely connected as one, it may rapidly disperse the charges that would otherwise collect in the upper panel 200 into a wide area.

When the first driver 400 positioned in the lower panel 100 transmits voltages to drive the gate lines, charges Qa may collect around the first driver 400 due to the potential differences between these voltages. These charges Qa may travel to a side of the upper panel 200 such that the upper panel 200 may become charged. If the charges Qa continuously accumulate without being dispersed, the charges may travel to the display area DA and cause undesirable light leakage. However, according to an exemplary embodiment of the present system and method, any charge Qa that may build up in the upper panel 200 are rapidly dispersed into a large area by the low resistance layer 240, thereby reducing or even preventing light leakage in the display area DA that may be caused by accumulated charge.

In one embodiment, such as that shown in FIG. 4, an overcoat 250 is positioned on the low resistance layer 240. The overcoat 250 may include an organic or inorganic insulating material and may have a flat surface. The overcoat 250 weakens an electric field that may be formed between the low resistance layer 240 and the display element 150 of the lower panel 100. Accordingly, the overcoat 250 reduces an influence that affects the arrangement of the liquid crystal molecules of the liquid crystal layer positioned between the lower panel 100 and the upper panel 200, thereby reducing texture.

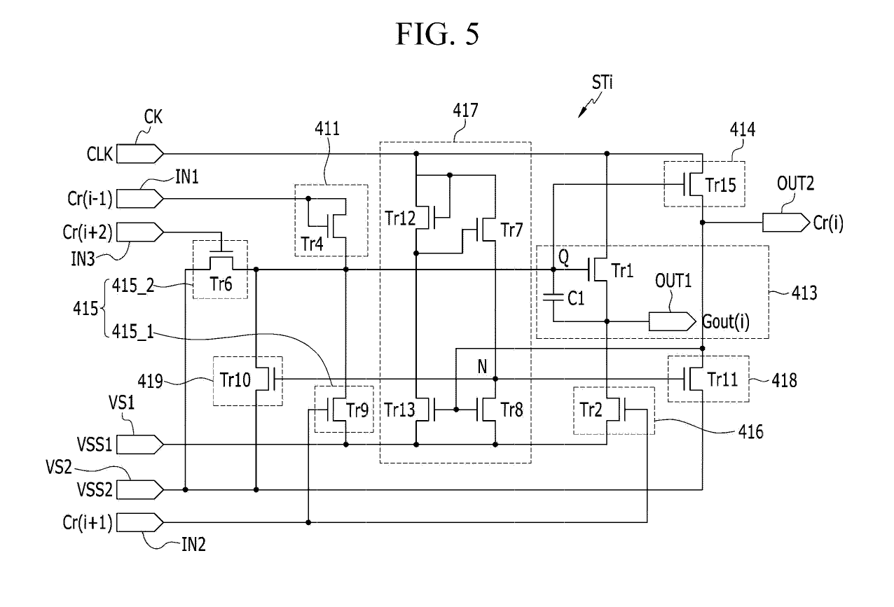

FIG. 5 is a circuit diagram of one stage of a driver according to an exemplary embodiment of the present system and method. Referring to FIG. 5, a stage STi may include a plurality of transistors Tr1, Tr2, Tr4, Tr6, Tr7, Tr8, Tr9, Tr10, Tr11, Tr12, Tr13, and Tr15 and at least one capacitor C1 along with a clock terminal CK, a first low voltage input terminal VS1, a second low voltage input terminal VS2, a first output terminal OUT1, a second output terminal OUT2, a first input terminal IN1, a second input terminal IN2, and a third input terminal IN3. FIG. 5 shows 12 transistors. However, the number of the transistors is not limited thereto.

The plurality of transistors and capacitors included in the stage STi may be grouped according to function into, for example, a buffer portion 411, a pull-up portion 413, a carry portion 414, a discharge portion 415, a pull-down portion 416, a switching portion 417, a first storage portion 418, and a second storage portion 419.

The buffer portion 411 transfers a carry signal received from a previous stage or a scanning start signal to the pull-up portion 413. The buffer portion 411 may receive, for example, a carry signal Cr(i−1) from the previous stage ST(i−1). The buffer portion 411 may include the transistor Tr4. An input terminal and a control terminal of the transistor Tr4 are common-connected (diode-connected) to the first input terminal IN1, and an output terminal is connected to a node Q.

The pull-up portion 413 is connected to the clock terminal CK, the node Q, and the first output terminal OUT1, and outputs a gate signal Gout(i) through the first output terminal OUT1. The pull-up portion 413 may include, for example, the transistor Tr1 and the capacitor C1. The control terminal of the transistor Tr1 is connected to the node Q, the input terminal is connected to the clock terminal CK, and the output terminal is connected to the first output terminal OUT1. The capacitor C1 is connected between the control terminal and the output terminal of the transistor Tr1. The capacitor C1 is charged in response to the carry signal Cr(i−1) provided by the buffer portion 411. When the clock signals CLK and CLKB from the clock terminal CK are at a high voltage and the voltage of the node Q is also at a high level (e.g., due to the charge of the capacitor C1), the transistor Tr1 is bootstrapped. In this case, the node Q is boosted from the charging voltage of the capacitor C1 to a boosting voltage. When the boosting voltage is applied to the control terminal of the transistor Tr1, the transistor Tr1 outputs the high voltage of the clock signals CLK and CLKB as a gate-on voltage Von through the first output terminal OUT1. When the voltage of the node Q drops to the low level, the transistor Tr1 is turned off, and the low voltage may be output to the first output terminal OUT1.

The pull-down portion 416 pulls down the voltage of the gate signal Gout(i) output to the first output terminal OUT1 to the first low voltage VSS1, which is applied to the first low voltage input terminal VS1 when a carry signal of a subsequent stage is received in the second input terminal IN2. For example, a carry signal Cr(i+1) from the next stage ST(i+1) may be received in the second input terminal IN2. The pull-down portion 416 may include the transistor Tr2. A control terminal of the transistor Tr2 is connected to the second input terminal IN2, an input terminal is connected to the first low voltage input terminal VS1, and an output terminal is connected to the first output terminal OUT1.

The carry portion 414 is connected to the clock terminal CK, the node Q, and the second output terminal OUT2, and outputs a carry signal Cr(i) through the second output terminal OUT2. The carry portion 414 outputs the high voltage of the clock signals CLK and CLKB received in the clock terminal CK as the carry signal Cr(i) when the high voltage is applied to the node Q. The carry portion 414 may include the transistor Tr15. The clock terminal CK is connected to an input terminal of the transistor Tr15, a control terminal is connected to the node Q, and an output terminal is connected to the second output terminal OUT2.

The first storage portion 418 stores the voltage of the carry signal Cr(i) that is output to the second output terminal OUT2 at the second low voltage VSS2 in response to the signal of the node N going to a high voltage level (e.g., higher than the threshold voltage of the transistor Tr11) for a period other than the output period of the high voltage of the carry signal Cr(i) (e.g., when carry portion 414 is not outputting the high voltage of the clock signals CLK and CLKB). The first storage portion 418 may include the transistor Tr11. A control terminal of the transistor Tr11 is connected with the node N, an input terminal is connected with the second low voltage input terminal VS2, and an output terminal is connected with the second output terminal OUT2. The transistor Tr11 maintains the voltage of the carry signal Cr(i) at the second low voltage VSS2 when the voltage of the node N is at a high level.

The switching portion 417 applies a signal, which has the same phase as the clock signals CLK and CLKB received in the clock terminal CK, to the node N for a period other than when the carry signal Cr(i) is output at a high voltage. The switching portion 417 may include the transistor Tr12, the transistor Tr7, the transistor Tr13, and the transistor Tr8.

The discharge portion 415 discharges the high voltage of the node Q to the second low voltage VSS2, which has a lower level than the first low voltage VSS1, in response to the carry signal from at least one of the subsequent stages.

The discharge portion 415 may include a first discharge portion 415_1 that includes the transistor Tr9, and a second discharge portion 415_2 that includes the transistor Tr6. The first discharge portion 415_1 discharges the voltage of the node Q to the first low voltage VSS1 that is applied to the first low voltage input terminal VS1 when the carry signal Cr(i+1) is received from the second input terminal IN2. The second discharge portion 415_2 discharges the voltage of the node Q to the second low voltage VSS2 that is applied to the second low voltage input terminal VS2 when the carry signal is applied to the third input terminal IN3. For example, the carry signal Cr(i+2) of the stage ST(i+2) after two stages may be received in the third input terminal IN3.

The second storage portion 419 may include the transistor Tr10. The second storage portion 419 maintains the voltage of the node Q at the second low voltage VSS2 in response to the signal of the node N going to a high voltage level (e.g., higher than the threshold voltage of the transistor Tr10) for the remaining period of the frame.

The structure of the stage STi of the gate driver 400 illustrated in FIG. 5 is an example, however the present system and method is not limited thereto. According to an embodiment, the first low voltage VSS1 may be about −7 V to −5 V, and the second low voltage VSS2 may be lower than the first low voltage VSS2. Also, the high voltage of the node Q may be significantly higher than the common voltage Vcom of the display area DA, and for example, may be more than about 20 V. As described above, the first low voltage VSS1 and the second low voltage VSS2 that are transmitted by the first driver 400 and the signal wire connected thereto, and the voltages of the nodes, such as node Q, may have large potential differences with the common voltage Vcom. If charges build up in the upper panel 200 due to the large potential differences and are not dispersed, the charges may be transmitted to the edge region of the display area DA and cause light leakage there.

However, according to an exemplary embodiment of the present system and method, the charges that would otherwise build up in a upper panel are rapidly dispersed by a low resistance layer, such as the low resistance layer 240 of FIG. 4, into a large area, thereby preventing light leakage and increasing the display quality of a display panel.

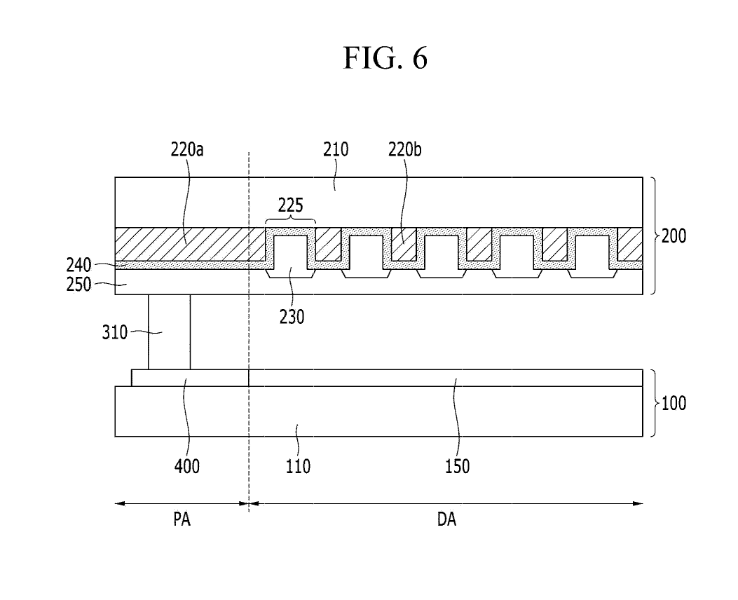

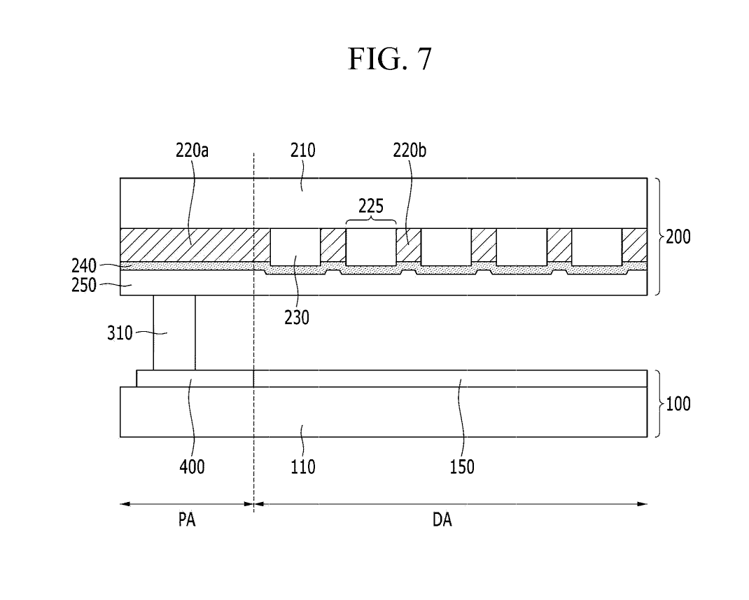

A display panel according to an exemplary embodiment of the present system and method is described with reference to FIG. 6 and FIG. 7 together with the aforementioned drawings. The same constituent elements as in the aforementioned exemplary embodiments are indicated by the same reference numerals, and the same descriptions are omitted. FIG. 6 and FIG. 7 are cross-sectional views of a display panel according to an exemplary embodiment of the present system and method.

First, referring to FIG. 6, a display panel according to an exemplary embodiment of the present system and method includes a sealant 310 that is positioned between the lower panel 100 and the upper panel 200 such that the two display panels 100 and 200 are combined with each other such that an inner space may be sealed therebetween. The sealant 310 may be positioned in the peripheral area PA.

A light blocking member is positioned on the insulation substrate 210 of the upper panel 200. The light blocking member may include at least a first light blocking portion 220a positioned in the peripheral area PA and a second light blocking portion 220b positioned in the display area DA. The first light blocking portion 220a may cover the first driver 400 of the peripheral area PA. The second light blocking portion 220b may be referred to as a black matrix and may prevent light leakage between the pixels PX. The second light blocking portion 220b includes a plurality of openings 225 positioned in the display area DA. An opening 225 may define a pixel area as a region in which each pixel PX displays the image.

The first light blocking portion 220a and the second light blocking portion 220b may be formed of the same material in the same process. The first light blocking portion 220a and the second light blocking portion 220b may include a pigment such as black carbon, or an organic, photosensitive material. The first light blocking portion 220a and the second light blocking portion 220b correspond to the above-described insulating layer 220.

As described above, the low resistance layer 240 may be positioned on the insulating layer 220, which, in the case of FIG. 6, includes the first light blocking portion 220a and the second light blocking portion 220b. The low resistance layer 240 includes at least a portion that covers the first light blocking portion 220a in the peripheral area PA. Accordingly, the low resistance layer 240 may be positioned between the first light blocking portion 220a of the peripheral area PA and the first driver 400 of the lower panel 100.

The low resistance layer 240, as shown in FIG. 6, may further include a portion that covers the second light blocking portion 220b in the display area DA and the openings 225. The other characteristics and functions of the low resistance layer 240 may be the same as the above-described exemplary embodiment shown in FIG. 4.

A plurality of color filters 230 may be positioned on the low resistance layer 240. Each color filter 230 may uniquely display one of the primary colors. The color filters may display, for example, three primary colors of red, green, and blue, three primary colors of yellow, cyan, and magenta, or four primary colors. The color filters 230 may cover the openings 225 of the second light blocking portion 220b and may be formed to elongate along a pixel column or a pixel row.

The overcoat 250 is positioned on the color filters 230. The overcoat 250 may prevent the color filters 230 from being exposed and provide a flat surface. The overcoat 250 may prevent an impurity such as a pigment of the color filter 230 and the light blocking member from flowing into the space enclosed by the sealant 310, that is, the liquid crystal layer (not shown) between the lower panel 100 and the upper panel 200.

Referring to FIG. 7, a display panel according to another exemplary embodiment includes a low resistance layer 240 that is positioned between the first and second light blocking members 220a and 220b and the overcoat 250 in some areas and the color filters 230 and the overcoat 250 in other areas. In this case, the low resistance layer 240 includes a portion that covers the first light blocking portion 220a positioned in the peripheral area PA such that the low resistance layer 240 may be positioned between the first light blocking portion 220a in the peripheral area PA and the first driver 400 of the lower panel 100. Also, the low resistance layer 240 may further include a portion that covers the second light blocking portion 220b and the openings 225 in the display area DA. The other characteristics and functions of the low resistance layer 240 may be the same as the above-described exemplary embodiments.

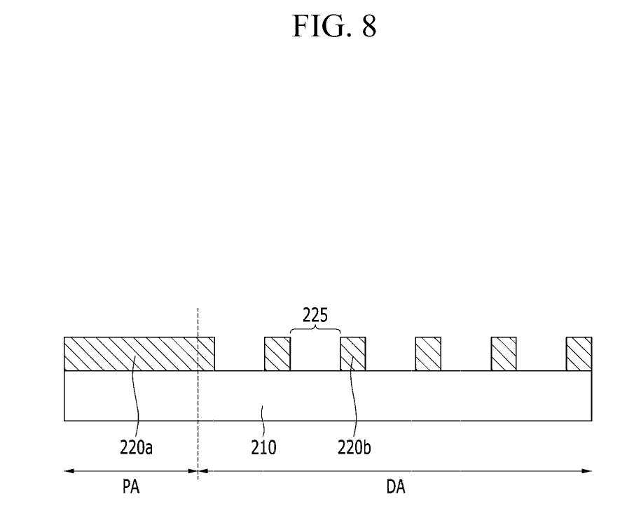

A manufacturing method of the upper panel according to an exemplary embodiment of the present system and method is described below with reference to FIG. 8 to FIG. 11 as well as FIG. 6.

FIG. 8 to FIG. 11 are cross-sectional views that sequentially show a structure at intermediate steps of a manufacturing process for a display panel, according to an exemplary embodiment of the present system and method.

First, referring to FIG. 8, the first light blocking portion 220a is formed in the peripheral area PA of the insulation substrate 210 and the second light blocking portion 220b, including the openings 225, are formed in the display area DA of the insulation substrate 210.

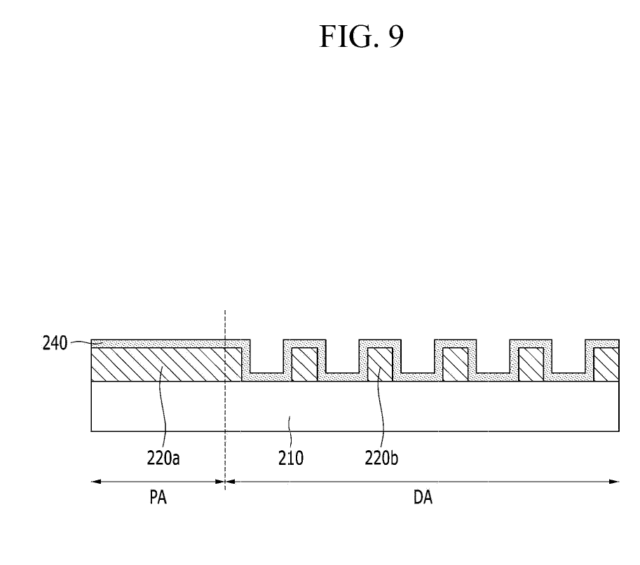

Next, referring to FIG. 9, the conductive material such as a metal oxide of IZO, ITO, and the like is deposited on the first light blocking portion 220a and the second light blocking portion 220b to form the low resistance layer 240. The low resistance layer 240 may or may not be patterned. If the patterning of the low resistance layer 240 is omitted, an additional mask for patterning the low resistance layer 240 is not required, and the low resistance layer 240 may be formed throughout the peripheral area PA and the display area DA of the insulation substrate 210.

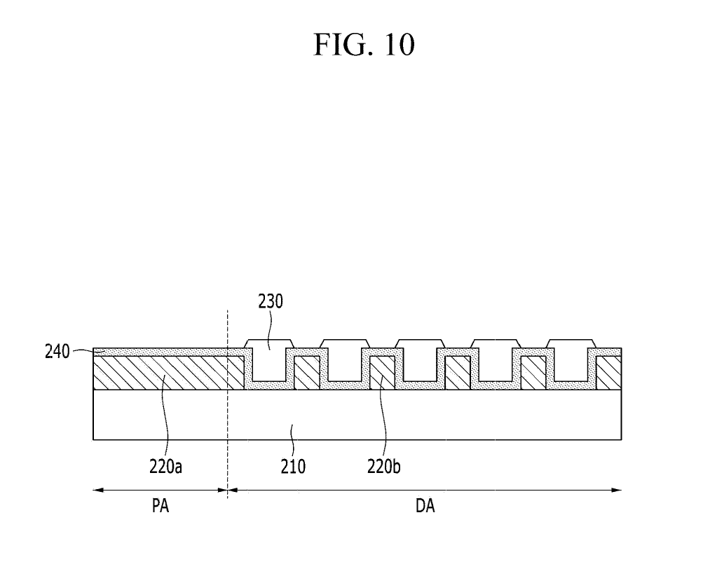

Next, referring to FIG. 10, a plurality of color filters 230 are formed on the low resistance layer 240. The color filters 230 may be formed to correspond to the openings 225 of the second light blocking portion 220b positioned in the display area DA.

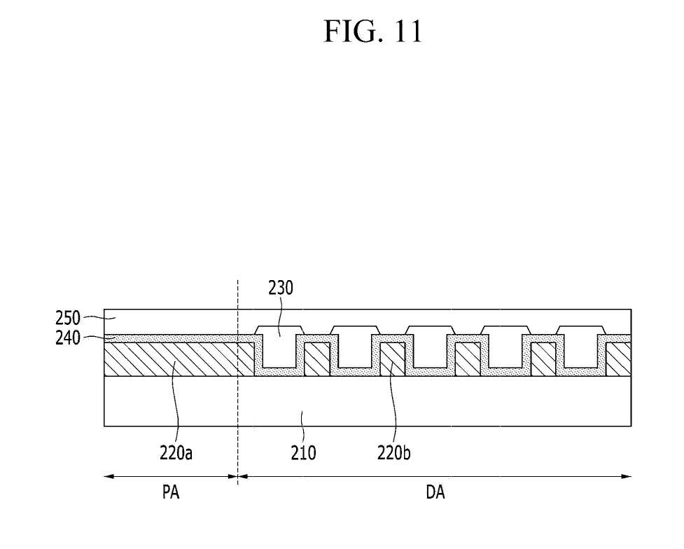

Next, referring to FIG. 11, an insulating material is deposited on the plurality of color filters 230 to form the overcoat 250.

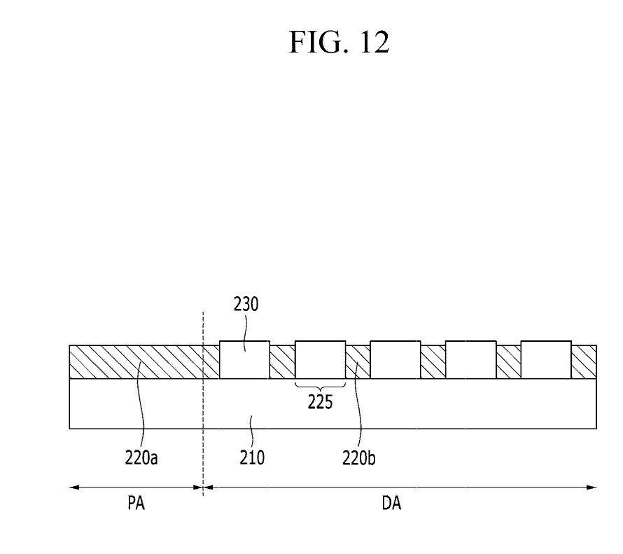

A manufacturing method of the upper panel according to another exemplary embodiment of the present system and method is described below with reference to FIG. 12 to FIG. 14 as well as FIG. 7.

FIG. 12 to FIG. 14 are cross-sectional views that sequentially show a structure at intermediate steps of a manufacturing process for a display panel according to an exemplary embodiment of the present system and method.

First, referring to FIG. 12, the first light blocking portion 220a is formed in the peripheral area PA of the insulation substrate 210 and the second light blocking portion 220b, including the openings 225, is formed in the display area DA of the insulation substrate 210. Next, a plurality of color filters 230 are formed on the second light blocking portion 220b. The color filters 230 may be formed at locations that correspond to the openings 225 of the second light blocking portion 220b positioned in the display area DA.

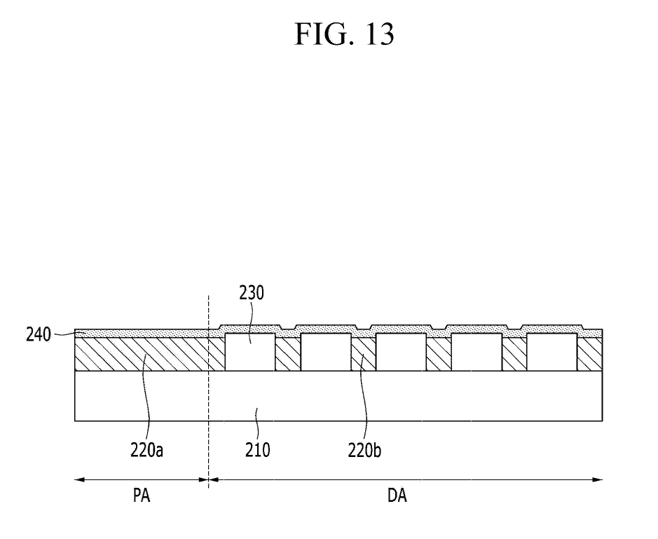

Next, referring to FIG. 13, the conductive material such as the metal oxide of IZO, ITO, and the like is deposited on the first light blocking portion 220a, the second light blocking portion 220b, and the color filter 230 to form the low resistance layer 240. The low resistance layer 240 may or may not be patterned. If patterning of the low resistance layer 240 is omitted, an additional mask for patterning the low resistance layer 240 is not required, and the low resistance layer 240 may be formed throughout the peripheral area PA and the display area DA of the insulation substrate 210.

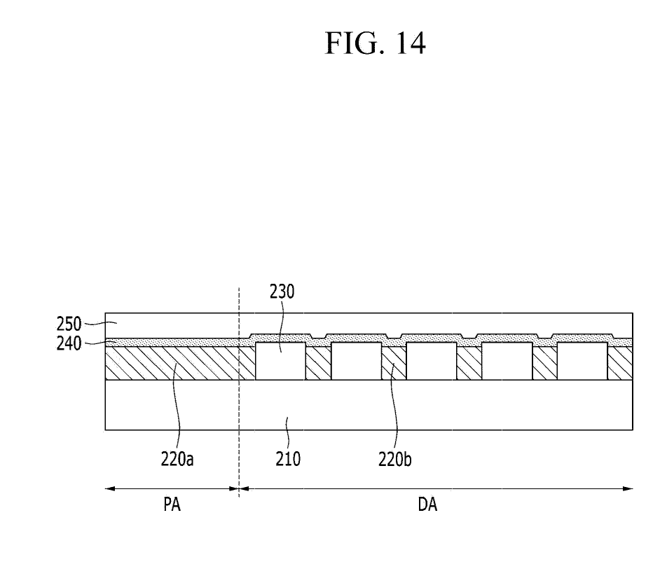

Next, referring to FIG. 14, the insulating material is deposited on the low resistance layer 240 to form the overcoat 250.

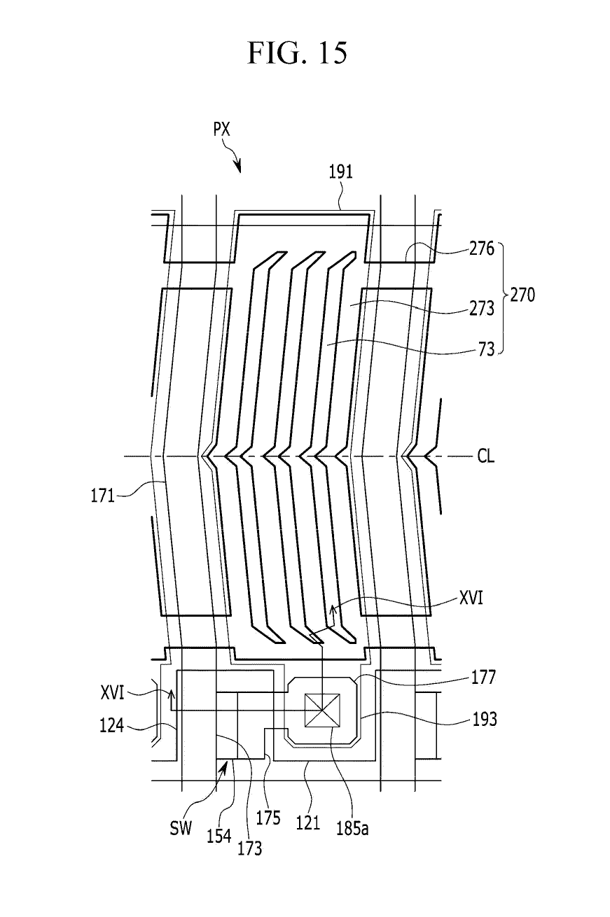

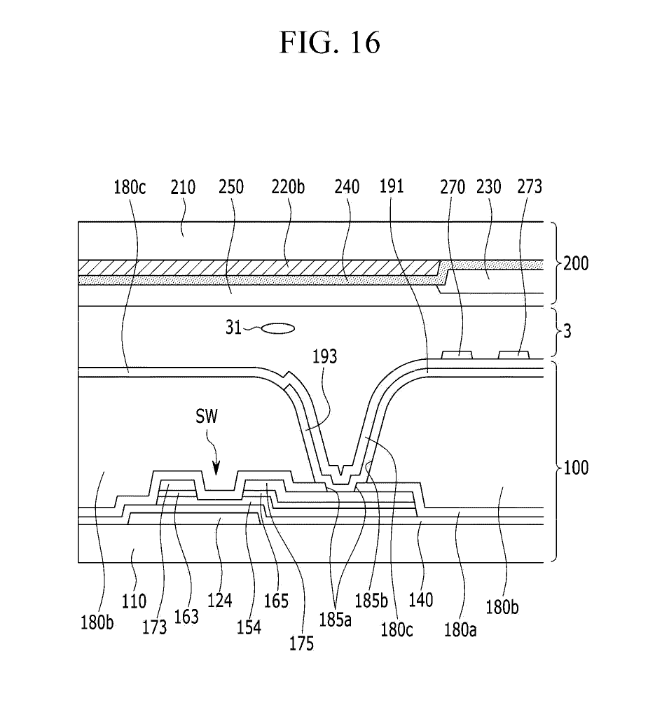

The structure of a display device according to an exemplary embodiment of the present system and method is described below with reference to FIG. 15 and FIG. 16.

FIG. 15 is a layout view of one pixel of a display panel according to an exemplary embodiment of the present system and method. FIG. 16 is a cross-sectional view of the display panel of FIG. 15 taken along a line XVI-XVI.

Referring to FIG. 15 and FIG. 16, a display device according to an exemplary embodiment of the present system and method, such as a liquid crystal display, includes a lower panel 100 and an upper panel 200 that face each other, and a liquid crystal layer 3 injected therebetween.

The liquid crystal layer 3 includes liquid crystal molecules 31 that have dielectric anisotropy. The liquid crystal molecules 31 may be aligned so that their long axes are parallel or perpendicular to the panels 100 and 200 without applying an electric field in the liquid crystal layer 3. The liquid crystal molecules 31 may be nematic liquid crystal molecules that have a structure in which the long-axial directions are spirally twisted from the lower panel 100 to the upper panel 200 (e.g., when the long axes are aligned perpendicular to the panels).

Referring to the lower panel 100, a gate conductor that includes a plurality of gate lines 121 is positioned on an insulation substrate 110 made of transparent glass, plastic, or the like. The gate line 121 may transfer a gate signal and mainly extend in a horizontal direction (orientation as shown in FIG. 15). The gate line 121 includes a gate electrode 124.

A gate insulating layer 140 made of silicon nitride (SiNx), silicon oxide (SiOx), or the like is formed on the gate conductor. A semiconductor 154 is positioned on the gate insulating layer 140. The semiconductor 154 may include amorphous silicon, polysilicon, or an oxide semiconductor. Ohmic contacts 163 and 165 may be further positioned on the semiconductor 154.

A data conductor that includes a data line 171, a source electrode 173 and a drain electrode 175 is positioned on the ohmic contacts 163 and 165 and the gate insulating layer 140. The data line 171 may transfer a data signal and mainly extend in a vertical direction (orientation as shown in FIG. 15) that crosses the gate line 121. The data line 171 may be periodically curved. For example, as illustrated in FIG. 15, each data line 171 may be curved at least once at a portion that corresponds to a horizontal center line CL of a pixel PX. The data line 171 includes the source electrode 173. According to the exemplary embodiment illustrated in FIG. 15, the source electrode 173 may be positioned on the same line as the data line 171 without protruding from the data line 171. The drain electrode 175 faces the source electrode 173. The drain electrode 175 may include a rod-shaped portion that extends substantially in parallel with the source electrode 173, and an extension 177 positioned opposite to the rod-shaped portion.

The gate electrode 124, the source electrode 173, and the drain electrode 175 form one thin film transistor (TFT) together with the semiconductor 154. The thin film transistor may function as a switching element SW for transmitting a data voltage on the data line 171.

A first passivation layer 180a is positioned on the data conductor, the gate insulating layer 140, and the exposed portion of the semiconductor 154. The first passivation layer 180a may be made of an organic insulating material or an inorganic insulating material. The first passivation layer 180a exposes a part of the drain electrode 175, for example, through a contact hole 185a in the extension 177, to a pixel electrode 191.

A second passivation layer 180b may be further positioned on the first passivation layer 180a. The second passivation layer 180b may include an inorganic insulating material or an organic insulating material. The second passivation layer 180b may include an opening 185b that corresponds to the contact hole 185a of the first passivation layer 180a. As shown, the edge of the opening 185b may enclose the edge of the contact hole 185a and may substantially accord with the edge of the contact hole 185a. In some cases, the second passivation layer 180b may be omitted.

The pixel electrode 191 may be positioned on the second passivation layer 180b. The pixel electrode 191 of each pixel PX may have a planar shape. The pixel electrode 191 may include a protrusion 193 for connecting with other layers. The protrusion 193 of the pixel electrode 191 is physically and electrically connected to the drain electrode 175 through the contact hole 185a to receive a voltage from the drain electrode 175. The pixel electrode 191 may be made of a conductive material such as a transparent conductive material metal of ITO or IZO.

A third passivation layer 180c may be positioned on the pixel electrode 191. The third passivation layer 180c may include an organic insulating material or an inorganic insulating material.

A common electrode 270 is positioned on the third passivation layer 180c. Common electrodes 270 positioned in the plurality of pixels PX are connected to each other through a connection bridge 276 and the like to transfer substantially the same common voltage Vcom. The common electrode 270 according to the exemplary embodiment of FIG. 15 may include a plurality of branch electrodes 273 that overlap with the pixel electrode 191, which has a planar shape. A slit 73 in which an electrode is removed is formed between the adjacent branch electrodes 273. The common electrode 270 may be made of a conductive material such as a transparent conductive material of ITO or IZO.

The pixel electrode 191, which receives the data voltage through the switching SW and the common electrode 270, which receives the common voltage Vcom, together generate an electric field in the liquid crystal layer 3 to control the directions, orientation, and/or positioning of the liquid crystal molecules 31 in the liquid crystal layer 3 and display an image. Particularly, the branch electrode 273 of the common electrode 270 generates a fringe field in the liquid crystal layer 3 together with the pixel electrode 191 to control alignment directions of the liquid crystal molecules 31. A liquid crystal display according to an exemplary embodiment of the present system and method may further include at least one polarizer, and may operate in a black mode (i.e., pixel has lowest transmittance level) or a white mode (i.e., pixel has highest transmittance level) in the absence of the electric field according to a polarization axial direction of the polarizer.

According to another exemplary embodiment of the present system and method, a laminating position of the pixel electrode 191 and the common electrode 270 may be changed.

Referring to the upper panel 200, the first light blocking member (not shown) and the second light blocking portion 220b are positioned on the insulation substrate 210 made of the transparent glass or plastic. The second light blocking portion 220b may include the portion that covers the switching element SW and may define the opening region of the pixel PX, that is, the pixel area.

The low resistance layer 240 according to an exemplary embodiment of the present system and method may be positioned on the second light blocking portion 220b.

A plurality of color filters 230 may be positioned on the low resistance layer 240. Alternatively, the deposition positions of the low resistance layer 240 and the color filter 230 may be exchanged.

The overcoat 250 is positioned on the color filter 230.

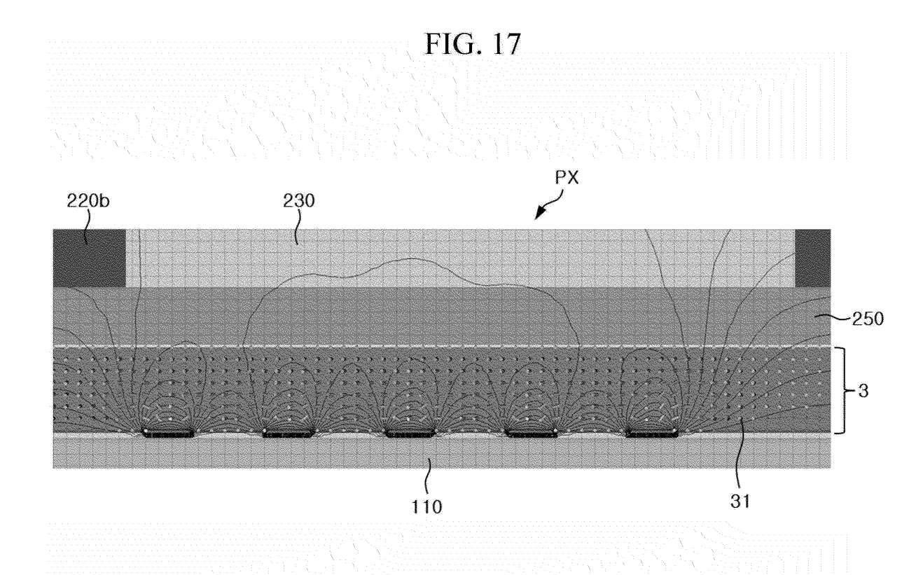

A simulation result of a liquid crystal arrangement according to a structure of the display device according to an exemplary embodiment of the present system and method is described below with reference to FIG. 17 to FIG. 22 along with FIG. 15 and FIG. 16.

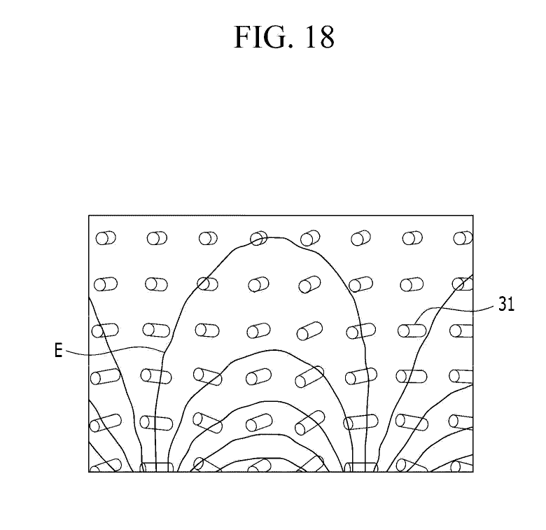

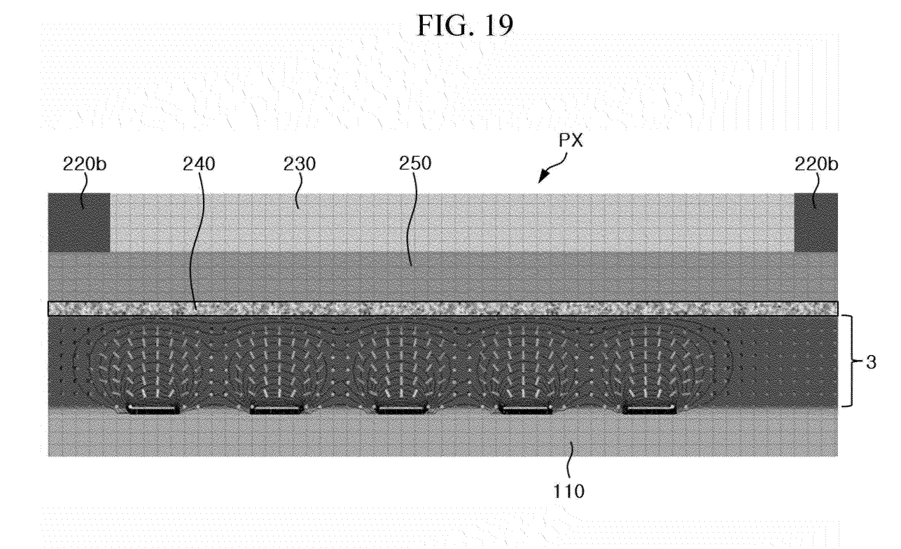

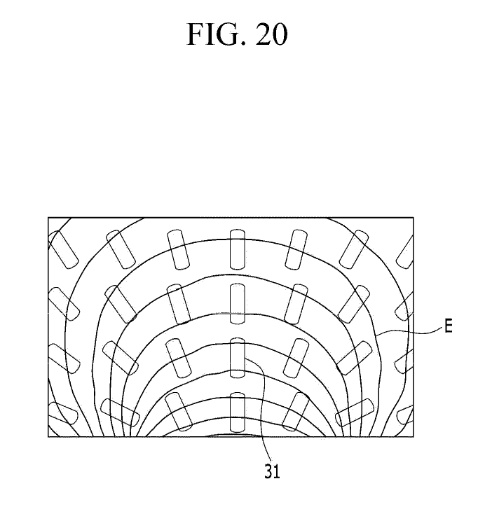

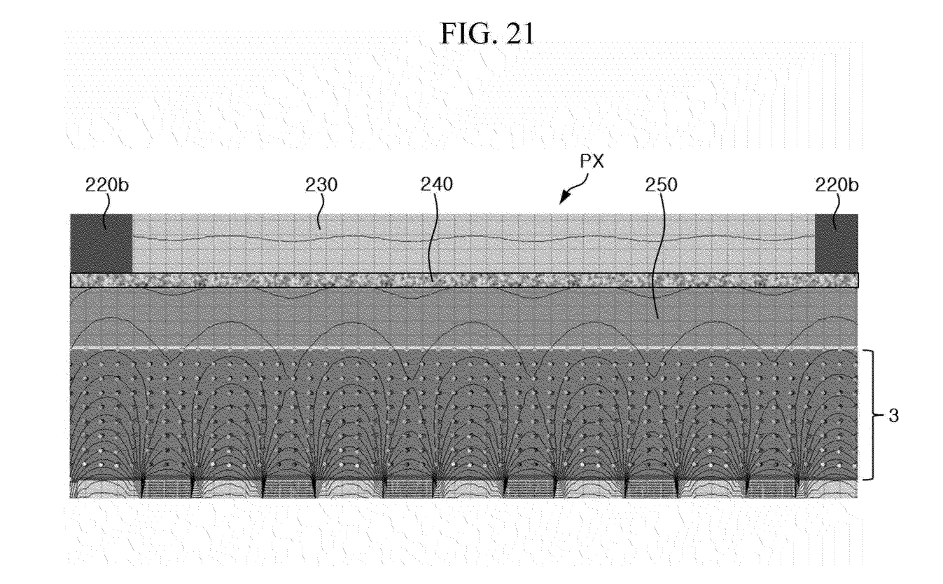

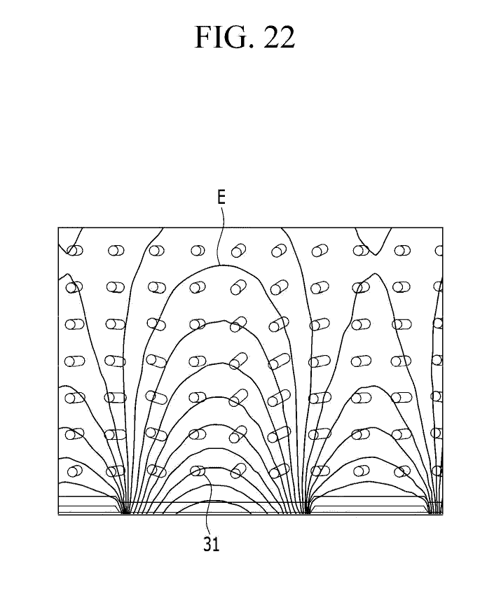

FIG. 17 is a simulation result that shows a movement of liquid crystal molecules when a pixel electrode and a common electrode of a display device generate an electric field in a liquid crystal layer, according to an exemplary embodiment of the present system and method. FIG. 18 is an enlarged view of a portion of FIG. 17. FIG. 19 is a simulation result that shows a movement of liquid crystal molecules when a pixel electrode and a common electrode of a display device generate an electric field to a liquid crystal layer, according to another exemplary embodiment of the present system and method. FIG. 20 is an enlarged view of a portion of FIG. 19. FIG. 21 is a simulation result that shows a movement of liquid crystal molecules when a pixel electrode and a common electrode of a display device generate an electric field to a liquid crystal layer, according to another exemplary embodiment of the present system and method. FIG. 22 is an enlarged view of a portion of FIG. 21.

The simulation results shown in FIG. 17 to FIG. 22 are examples in which the long axis of the liquid crystal molecule 31 is aligned parallel to the display panels 100 and 200 in the absence of an electric field. That is, the liquid crystal molecules 31 are arranged on the surface and are almost parallel to the surfaces of the display panels 100 and 200 such that a gray of the desired image may be expressed.

Referring to FIG. 17 and FIG. 18, the above-described low resistance layer 240 (such as shown in FIG. 16) is not used in the upper panel 200 of a liquid crystal display. In this case, the liquid crystal molecules 31 of the liquid crystal layer 3 may be substantially controlled and rearranged by the electric field E generated by the voltage difference of the pixel electrode 191 of the lower panel 100 and the common electrode 270. This enables the liquid crystal display to exhibit high transmittance and lower texture. However, because the low resistance layer 240 is not used to disperse charges at the edge of the display area DA, light leakage may occur due to charges that build up in the upper panel 200.

Referring to FIG. 19 and FIG. 20, the structure in FIG. 19 differs from that of FIG. 17 in that the low resistance layer 240 is used in the upper panel 200 between the overcoat 250 and the liquid crystal layer 3. The presence of lower resistance layer 240, however, causes an undesirable electric field to be generated between the low resistance layer 240 of the upper panel 200 and the pixel electrode 191 of the lower panel 100 or the common electrode 270, which may then cause the liquid crystal molecules 31 of the liquid crystal layer 3 to be arranged in the direction perpendicular to the surface of the display panels 100 and 200. Accordingly, an unstable texture region in which the arrangement of the liquid crystal molecule 31 is not controlled may be generated.

Referring to FIG. 21 and FIG. 22, like the liquid crystal display according to the exemplary embodiment shown in FIG. 15 and FIG. 16, the low resistance layer 240 is positioned between the second light blocking portion 220b and the overcoat 250. The overcoat 250 weakens the electric field between the low resistance layer 240 and the pixel electrode 191 of the lower panel 100 or the common electrode 270. Accordingly, compared to the simulation result shown in FIG. 19 and FIG. 20, occurrences in which the liquid crystal molecules 31 are arranged perpendicular to the surfaces of the display panels 100 and 200 may be reduced, thereby reducing the texture of the display. In an embodiment in which the color filters are further positioned between the low resistance layer 240 and the liquid crystal layer 3, the vertical electric field between the low resistance layer 240 and the pixel electrode 191 of the lower panel 100 or the common electrode 270 may be further weakened.

In this case, as described above, the low resistance layer 240 is positioned in the upper panel 200 such that the charges that are gathered into the upper panel 200 are rapidly dispersed into a large area, thereby reducing the light leakage in the display area DA. That is, when the pixel electrode 191 and the common electrode 270 that form the electric field in the liquid crystal layer 3 (according to an image signal) are all positioned in the lower panel 100, the noise charges that are gathered in the upper panel 200 may be rapidly dispersed through the low resistance layer 240.

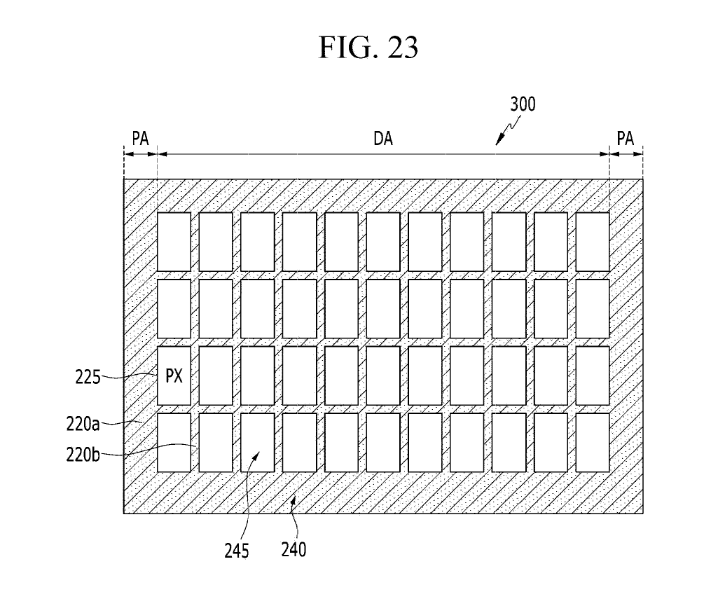

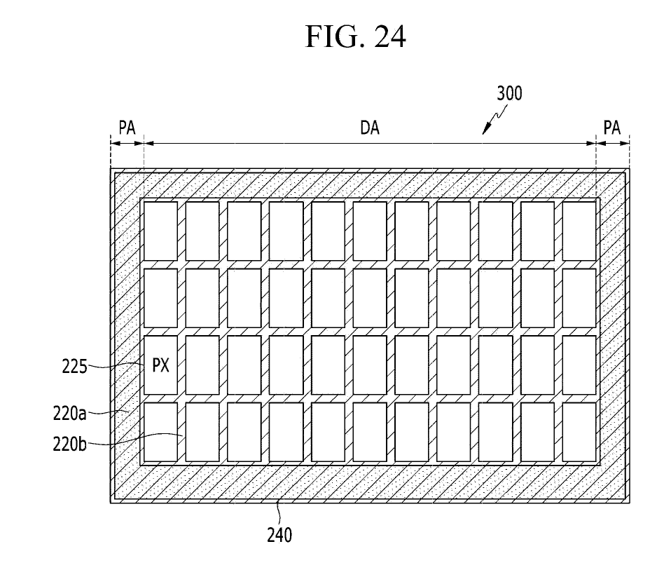

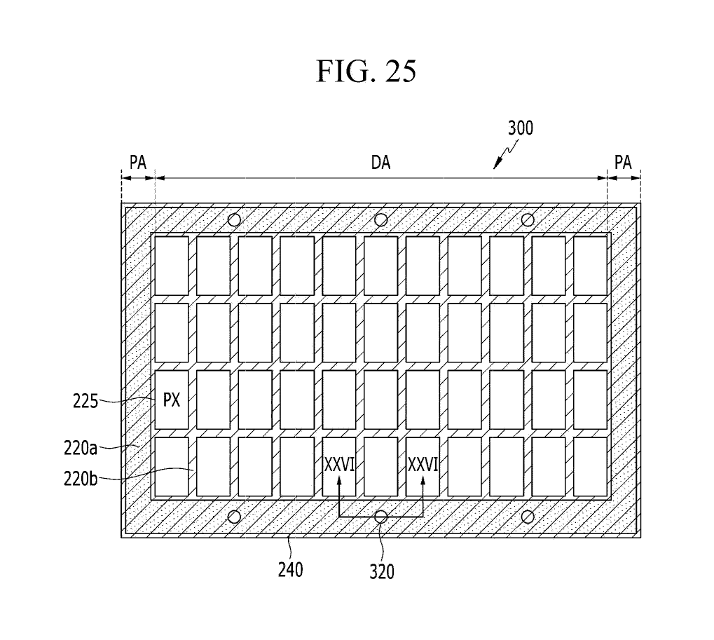

A display panel 300 included in the display device according to an exemplary embodiment of the present system and method is described below with reference to FIG. 23 to FIG. 27.

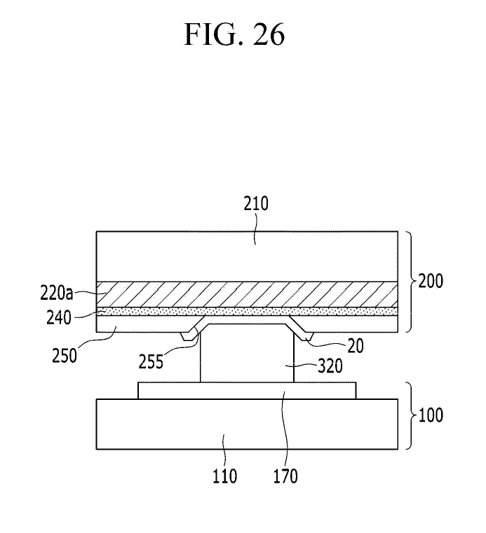

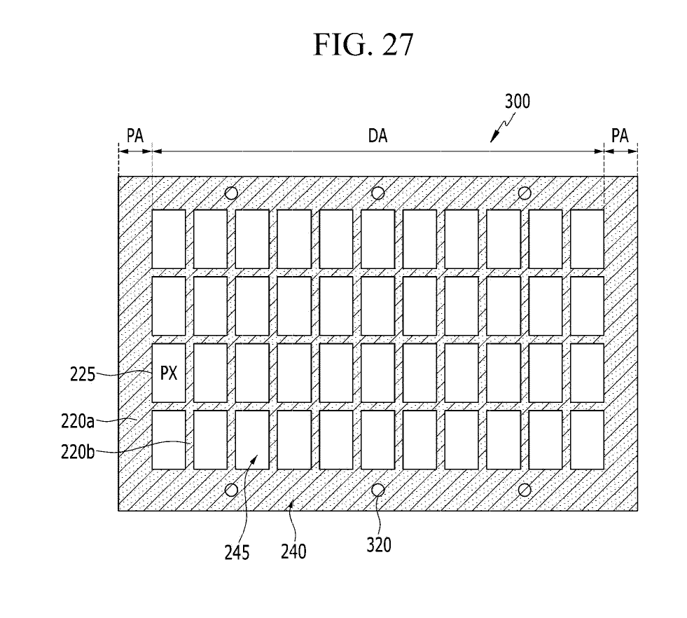

FIG. 23, FIG. 24, and FIG. 25 are layout views of a display panel according to one or more exemplary embodiments of the present system and method. FIG. 26 is a cross-sectional view of the display panel of FIG. 25 taken along a line XXVI-XXVI. FIG. 27 is a layout view of a display panel according to an exemplary embodiment of the present system and method.

Referring to FIG. 23, a display panel 300 of the display device may be substantially the same as the above-described embodiments of a display panel. However, the planar shape of the low resistance layer 240 of FIG. 23 may be different. Referring to FIG. 23, the low resistance layer 240 is formed on the entire surface of the display panel 300 and may include a plurality of opening regions that correspond to the pixels PX in the display area DA. That is, the plurality of openings 245 corresponds to the openings 225 of the second light blocking portion 220b. Accordingly, because the low resistance layer 240 does not overlap (in a layout view) with the pixel electrodes or common electrodes that are generally in the opening regions of the pixels PX, the vertical electric field generated between the low resistance layer 240 of the upper panel 200 and the lower panel 100 may not occur in the opening regions of the pixels PX and, therefore, may not decrease the transmittance of the pixels. Also, unstable texture regions like the simulation result shown in FIG. 19 and FIG. 20 may be prevented.

Next, referring to FIG. 24, a display panel 300 of the display device according to another exemplary embodiment may be substantially the same as that shown in FIG. 23. The planar shape of the low resistance layer 240, however, may be different.

Referring to FIG. 24, the low resistance layer 240 may overlap the first light blocking portion 220a but not the second light blocking portion 220b of the display area DA. That is, the low resistance layer 240 may include one opening that corresponds to the display area DA. The low resistance layer 240 may be formed in a portion or substantially all of the peripheral area PA of the display panel 300. In this case, the charges that are gathered in the upper panel 200 may be rapidly dispersed into a large area through the low resistance layer 240. At the same time, because the low resistance layer 240 does not overlap with the display area DA where the pixel electrodes and common electrodes are located, no undesirable vertical electric fields may be generated in the display area DA, thereby increasing the transmittance of the pixels PX. Also, unstable texture regions like the simulation result shown in FIG. 19 and FIG. 20 may be prevented.

Next, referring to FIG. 25 and FIG. 26, a display panel 300 of the display device according to another exemplary embodiment may be substantially the same as that shown in FIG. 24. The display panel 300 of FIG. 25, however, may include at least one short portion 320 that is positioned in the peripheral area PA of the display panel 300.

Referring to FIG. 26, in the peripheral area PA of the display panel 300, the upper panel 200 includes the insulation substrate 210 and the first light blocking portion 220a that is positioned on the insulation substrate 210. The low resistance layer 240 may be positioned on the first light blocking portion 220a, and the overcoat 250 is positioned thereon. The overcoat 250 may have at least one contact hole 255 that exposes the low resistance layer 240. A contact assistant 20 may be positioned on the overcoat 250. The contact assistant 20 contacts the low resistance layer 240 in the contact hole 255 so as to be electrically connected to it.

In the peripheral area PA of the display panel 300, the lower panel 100 includes the insulation substrate 110, and a voltage wire 170 that transmits a predetermined voltage such as a ground voltage may be positioned on the insulation substrate 110. The voltage wire 170 includes a portion that faces the contact assistant 20 of the upper panel 200.

At least one short portion 320 is positioned between the lower panel 100 and the upper panel 200. The short portion 320 includes a conductive material, thereby electrically connecting the contact assistant 20 of the upper panel 200 and the voltage wire 170 of the lower panel 100. Thus, a predetermined voltage such as the ground voltage may be applied to the low resistance layer 240 to prevent voltage rippling in the low resistance layer 240 that may be caused by the voltage change of the first driver 400 of the lower panel 100. Accordingly, the low resistance layer 240 that has the predetermined voltage applied to it may completely remove the charges transmitted to the upper panel 200 and may prevent display deterioration that may be caused by voltage rippling in the low resistance layer 240.

Next, referring to FIG. 27, a display panel 300 of the display device according to an exemplary embodiment may be substantially the same as the display panel shown in FIG. 23. The planar shape of the low resistance layer 240, however, may be different. Referring to FIG. 27, like FIG. 23, the low resistance layer 240 may include a plurality of openings 245 that correspond to the openings 225 of the second light blocking portion 220b while being formed on the entire surface of the display panel 300. That is, the low resistance layer 240 may also include the portion that faces the second light blocking portion 220b of the display area DA.

While this system and method has been described in connection with several exemplary embodiments, it is understood that the system and method is not limited to the disclosed embodiments. One of ordinary skill in the art would understand that various modifications and equivalent arrangements are within the spirit and scope of the present system and method.

### DESCRIPTION OF SYMBOLS

3: liquid crystal layer
100: lower panel
110, 210: insulation substrate
191: pixel electrode
200: upper panel
220a, 220b: light blocking member
240: low resistance layer
270: common electrode
300: display panel
400: first driver
500: second driver

What is claimed is:

1. A display device comprising:
a first panel that includes:
a first insulation substrate including a display area and a peripheral area around the display area,
a plurality of signal lines positioned in the display area, and
a driving circuit integrated in the peripheral area and connected to the plurality of signal lines;
a second panel that includes:
a second insulation substrate facing the first insulation substrate,
an insulating layer positioned on the second insulation substrate,
a conductive low resistance layer positioned on the insulating layer and having lower resistance than the insulating layer, and
an overcoat positioned on the low resistance layer and including an insulating material; and
a light transmitting layer,
wherein the low resistance layer includes a first portion facing the driving circuit, and the first and second panels are combined with the light transmitting layer positioned therebetween.

2. The display device of claim 1, further comprising
a first electrode and a second electrode positioned on the first insulation substrate,
wherein the first electrode and the second electrode are capable of forming an electric field according to an image signal between the first insulation substrate and the second insulation substrate.

3. The display device of claim 2, wherein
the first portion covers substantially most of the peripheral area.

4. The display device of claim 3, further comprising
a color filter positioned between the low resistance layer and the overcoat.

5. The display device of claim 2, wherein
the low resistance layer includes an opening corresponding to the display area.

6. The display device of claim 5, further comprising
a short portion positioned between the first insulation substrate and the second insulation substrate,
wherein the short portion is connected to the low resistance layer.

7. The display device of claim 6, further comprising
a voltage wire positioned on the first insulation substrate and transmitting a predetermined voltage,
wherein the short portion is connected to the voltage wire.

8. The display device of claim 7, wherein
the overcoat includes a contact hole exposing the low resistance layer.

9. The display device of claim 8, further comprising
a color filter positioned between the low resistance layer and the overcoat.

10. The display device of claim 9, wherein
the driving circuit generates a gate signal including a gate-on voltage and a gate-off voltage.

11. The display device of claim 2, wherein
the low resistance layer further includes a second portion positioned in the display area, and
the second portion is connected to the first portion.

12. The display device of claim 11, further comprising
a color filter positioned between the low resistance layer and the overcoat.

13. The display device of claim 11, wherein:
the insulating layer includes a first light blocking portion positioned in the peripheral area and a second light blocking portion positioned in the display area;
the second light blocking portion includes a plurality of first openings; and
the second portion includes a second opening facing the first openings.

14. The display device of claim 13, further comprising
a short portion positioned between the first insulation substrate and the second insulation substrate, and
the short portion is connected to the low resistance layer.

15. The display device of claim 14, further comprising
a voltage wire positioned on the first insulation substrate and transmitting a predetermined voltage,
wherein the short portion is connected to the voltage wire.

16. The display device of claim 15, wherein
the overcoat includes a contact hole exposing the low resistance layer.

17. The display device of claim 16, further comprising
a color filter positioned between the low resistance layer and the overcoat.

18. The display device of claim 17, wherein
the driving circuit generates a gate signal including a gate-on voltage and a gate-off voltage.

19. The display device of claim 1, further comprising
a color filter positioned between the low resistance layer and the overcoat.

20. The display device of claim 1, wherein
the driving circuit generates a gate signal including a gate-on voltage and a gate-off voltage.
